(19) United States
(12) Patent Application Publication
(10) Pub. No.: US 2026/0229106 A1
(43) Pub. Date: Aug. 6, 2026

(54) METHOD FOR DETECTING AND DISPLAYING AN INDICATOR REPRESENTING A PROCESS

(71) Applicant: GEA WESTFALIA SEPARATOR GROUP GMBH, Oelde (DE)

(72) Inventors: Daniel BUSSMANN, Oelde (DE); Jan PINTER, Hamm (DE); Lars WITTKAEMPER, Münster (DE); Rina MUCAJ, Oelde (DE)

(21) Appl. No.: 19/110,918

(22) PCT Filed: Sep. 12, 2023
(86) PCT No.: PCT/EP2023/075041

§ 371 Date: Mar. 12, 2025

(30) Foreign Application Priority Data
Sep. 13, 2022 (EP) 22195445.6

(51) Int. Cl. G08B 21/18; B04B 1/04; B04B 11/02; B04B 13/00

(52) U.S. Cl. CPC G08B 21/187; B04B 1/04; B04B 11/02; B04B 13/00

(57) ABSTRACT

One or more key performance indicators representing a centrifugal separation process by a centrifuge are detected and displayed. The separation process with the centrifuge is performed and one, two or more different operating parameters of the centrifugal separation process of the assembly with the centrifuge are detected with one or more detectors associated with the assembly. The detected operating parameters are converted into two or more respective specific key performance indicators with a data processing unit. An aggregate key performance indicator is determined from the two or more specific key performance indicators by applying a predetermined set of rules to determine a weighted average of the two or more specific key performance indicators. At least the aggregate key performance indicator is displayed on a user interface.

### BACKGROUND AND SUMMARY OF THE INVENTION

Exemplary embodiments of the invention relate to a method for detecting and displaying of one or more key performance indicators representing a separation process.

A key performance indicator (KPI) is a quantifiable performance indicator used in an industrial process based on one or more measurements and a calculation. It can be used to monitor, analyze and optimize an industrial process such as a centrifugation process. The temporal course of an industrial centrifugation process, however is subject to many influencing factors making it especially difficult to monitor and analyze the centrifugation process.

U.S. Pat. No. 6,143,183 discloses computerized systems for monitoring, diagnosing, operating, and controlling parameters and processes of continuous feed centrifuges. The monitoring sensors sense process and other parameters including machine operation parameters and operating parameters related to the input and output streams of the centrifuge. An operator can monitor the centrifuge's real time performance and historical log. Software for this includes operator screens for data display and message displays. Pre-formatted reports present the retrieved data to show information such as; operating hours, alarms generated, number of starts, number of trips, electrical power used, maximum and minimum values for measured variables, total feed processed, etc. Using the operating data, the centrifuge manufacturer can recommend measures to avoid down time and to optimize run time. Also, maintenance procedures may be suggested based on the operating log of elapsed run time, and unusual operating conditions such as high bearing temperatures or frequent high torque trips. The operating data log thus helps to troubleshoot various operating conditions of the centrifuge. However, due to the relatively large amount of sensed parameter data which will usually be presented to the user in form of reports, it is relatively difficult for the user to gain an overview of the measured parameters in order to monitor and analyze the process, and to react in a timely manner when issues arise.

Accordingly, exemplary embodiments of the present invention are directed to a method allowing a separation process to be more efficiently monitored and analyzed, thus allowing the operator or plant manager to promptly act in case of sub-optimal operations of the separation process.

According to an aspect there is a method for detecting and displaying of one or more key performance indicators representing a centrifugal separation process carried out with an assembly comprising a centrifuge, the method comprising the following steps:
(A) executing the separation process with the assembly comprising the centrifuge;
(B) detecting one, two, or more different operating parameters of the centrifugal separation process of the assembly with the centrifuge with one or more means of detection associated with the assembly;
(C) converting the detected operating parameters into two or more respective specific key performance indicators with a data processing unit;
(D) determining an aggregate key performance indicator from the two or more specific key performance indicators by applying a predetermined set of rules to determine a weighted average of the two or more specific key performance indicators; and
(E) displaying at least the aggregate key performance indicator on a user interface.

The aggregate key performance indicator is hereinafter also referred to with the abbreviation AKPI.

In accordance with this method, the centrifugal separation process can be more easily monitored and analyzed than in the cited state of the art. In preferred embodiments, the information can in turn be used to optimize the industrial process. Preferably, at least the steps C) to E) are computer implemented method steps.

In a preferred embodiment, the centrifuge of the assembly may be provided for executing a separation process which separates a fluid-a suspension-into components of different density in a centrifugal field. Centrifuges in the context of this disclosure especially comprise separators and decanters. In separators and decanters, different separation operations can be performed, for example separating and/or clarifying. Clarifying is the separation of solids from a liquid. In contrast, separating is the separation of two liquids with and without the simultaneous separation of solids.

The centrifuge may be used for a continuous separation process. This means that the centrifuged material is fed in without interruption and one or more of the separated phases are discharged without interruption. However, a solid phase as sludge or slurry can be discharged either continuously or discontinuously.

Although the temporal course of clarification or separation is subject to many influencing factors, the invention improves the monitoring of a centrifugal separation process by converting the detected operating parameters into two or more respective specific key performance indicators with a data processing unit, by determining an aggregate key performance indicator from the two or more specific key performance indicators through applying a predetermined set of rules to determine a weighted average of the two or more specific key performance indicators, and by displaying at least the aggregate key performance indicator on a user interface.

Thus, compared to the state of the art a user gains a very good and improved overview of the separator efficiency and can more easily detect a failure or even potential hazards, risks and areas for potential process improvement. Also, a direct indication of critical changes in the plant efficiency is achieved.

Preferably, the respective specific key performance indicators are calculated from two or more Sub key performance indicators, of which one or more is calculated from the two or more different operating parameters, respectively. According to a further advantageous embodiment of this variant, it is also possible that one or more of the respective Sub key performance indicators are calculated from one or more Sub Sub key performance indicators, of which one or more is calculated from one or more of the two or more different operating parameters, respectively. These embodiments contribute to optimize the analysis.

In preferred embodiments of the invention, the weighting of important KPIs/Sub KPIs/Sub Sub KPIs can be increased compared to an equal weight of all KPIs/Sub KPIs/Sub Sub KPIs to ensure that these have more influence on the efficiency of the assembly when they deteriorate or enhance. In contrast to this, the weighting of less important KPIs/Sub KPIs/Sub Sub KPIs can be decreased compared to an equal weight of all KPIs/Sub KPIs/Sub Sub KPIs to ensure that these do not affect the efficiency of the assembly heavily when worsening or improving. Weighting the KPIs/Sub KPIs/Sub Sub KPIs thus enables the use of more critical operating parameters for the monitoring of the efficiency of the assembly. This way, for an example, the critical operating parameter flow rate can have an increased impact on its associated at least one key performance indicator, Sub key performance indicator, Sub Sub key performance indicator, etc. than other, less important parameters. Hence, critical process issues can be noticed quicker than less important issues.

Thus, it is either possible that one or more of the respective Sub key performance indicators are calculated directly from one or more of the operating parameters and that one or more others of the respective Sub key performance indicators are calculated indirectly from one or more Sub Sub key performance indicators.

In a preferred embodiment, different panels are opened one after the other on the dashboard in order to unfold the one or more of the key performance indicators into at least two or more Sub key performance indicators. Thus, the user can scroll through the one or more of said KPIS, Sub KPIs and/or Sub Sub KPIs which also optimizes the analysis. It is also possible to display the one or more operating parameters in this way on a panel of the dashboard.

This embodiment also offers the opportunity to take a detailed look into the calculated results as the KPIs are split into Sub KPIs and—preferably—Sub Sub KPIs. This gives the operator or plant manager the possibility to directly detect possible deviations and immediately start eliminating the negative impacts in order to prevent failure which could cause additional downtime of the assembly.

Also, an easy access to data evaluation for operators as well as for plant managers may also be achieved by this embodiment. A combination of an AKPI with a direct link to a defined KPI structure improves operating risk assessment and mitigation, as well as equipment troubleshooting.

Also, the KPI structure can provide data output that indicate an area of concern of the assembly, for example of the centrifuge, with a higher specificity than a less structured, unweighted measure of equipment effectiveness might achieve.

In a preferred embodiment, the method comprises determining weights prior to step (B). The actual weighting factor can be determined based on experience and can easily be adjusted to an individual definition of efficiency defined by a user. Preferably, the weighting can be changed by the user.

A deviation of parameters related to an internal state of the system allows the operator to promptly act in case an issue with the equipment, especially the assembly or the centrifuge, occurs or arises. It may also be possible to increase the efficiency of the machine, as problems or malfunctions can immediately be counteracted and mitigated.

In different preferred embodiments, the centrifugal separation process that is executed with the assembly comprising the centrifuge, may be one: milk skimming, milk clarification, bacterial removing of milk/whey, yeast separation in beer or fermented medias (with a beer separator or a wine separator), juice separation, whey separation, whey skimming, separation of coffee or concentrated coffee, separation of proteins, separation of animal-based fats, separation of fermentation broth, separation of chemicals, separation of pharmaceutical, separation of yoghurt, separation of butter oil, separation of crude oil, separation of wastewater, and separation of bilge water.

Preferably, the one or more means of detection are associated with the centrifuge, the one or more means of detection comprising one or more sensors (the term “sensor” also comprises a counter).

The one or more sensors for measuring can be provided on or in the centrifuge. Thus, the operating parameter may be determined in or on the centrifuge or in an environment of the centrifuge.

In a preferred embodiment, the one or more operating parameters comprise one or more of: production volume per unit time, production time, discharge time, discharge volume, production temperature, discharge temperature, clean-in-place time, energy clean in place, energy production, startup energy, energy sanitization, difference standardized milk, difference standardized cream, acid time, acid conductivity, acid temperature, caustic time, caustic conductivity, caustic temperature, total discharges, available time, clean in place time, startup time, sanitization time, failure downtime, number of major failures, and number of minor failures.

These operating parameters can be determined by measurements, preferably by measurements with the one or more sensors. A single operating parameter can also be defined to be a KPI or Sub KPI or Sub Sub KPI.

In a preferred embodiment, the one or more specific key performance indicator(s) comprise(s) one or more of the KPIs: performance, quality, and availability.

In preferred embodiments:
the performance key performance indicator is calculated at least from one or more of the Sub KPIs: production, clean-in-place, energy; and/or
the quality key performance indicator is calculated at least from the Sub KPIs quality clean in place and quality product; and/or
the availability key performance indicator is calculated at least from one or more of the Sub KPIs: machine availability time and failure.

The invention also is directed to a system comprising an assembly with a centrifuge and one or more sensors, further comprising a data processing unit with a user interface unit connected therewith, the user interface unit comprising an electronic display comprising a graphical user interface, said system being set up to execute a method as described above.

In a preferred embodiment, the data processing unit may comprise a programmable logic controller, a data acquisition unit, a storage unit, and a data processor.

In a preferred embodiment, the data processing unit comprises a cloud computing unit, which comprises a storage unit.

In one embodiment, the data processing unit may comprise a cloud computing unit, which comprises a storage unit. Preferably, the operating parameters from step (B) are stored in the storage unit of said cloud computing unit. Further, in one embodiment, steps (C) and (D) are executed by the cloud computing unit.

In one embodiment, step (E) comprises retrieving one or more of the specific key performance indicators and/or the operating parameters from the cloud computing unit prior to display.

In one embodiment, the one or more sensors are one or more of a temperature sensor, a gyroscope, a pressure sensor, a microscope, an ammeter, a voltmeter, a humidity sensor, an accelerometer, a flowmeter, a mass flowmeter, a particle sensor, a scale, a chemical sensor or a biosensor, an altimeter, an inertial measurement unit, an encoder, a proximity sensor, a spectroscope, a frequency sensor, or a speedometer.

In one embodiment, the one or more sensors are one or more of an infrared sensor, an ultrasonic sensor, an optical sensor, a capacitive sensor, a piezoelectric sensor, a piezoresistive sensor, a thermoelectric sensor, a triboelectric sensor, a resonator sensor, a magnetic sensor, an anemometer, an electromagnetic sensor, a hall effect sensor, an inductive sensor, an electrostatic sensor, and/or an electro-optical sensor.

The invention also provides a program provided with instructions that effect the execution of a method according to one of the disclosed methods by a system.

### BRIEF DESCRIPTION OF THE DRAWING FIGURES

In the following, the invention is described in more detail with reference to the drawings on the basis of exemplary embodiments, whereby further advantages of the invention will become clear. Insofar as individual or several features are described below in connection with an exemplary embodiment, the invention is not limited thereto; rather, these features can also be used in other embodiments shown or not shown in the drawings. Moreover, single or multiple features may be illustrated together in one exemplary embodiment. This is advantageous, but it is not mandatory. These features can also be used together with other features of other embodiments shown and not shown. The drawings show:

FIG. 1 a schematic representation of a first embodiment of a system comprising an assembly with a centrifuge and one or more sensors and a data processing unit with a user interface unit connected therewith, configured to execute a method according to claim 1;

FIG. 2 a schematic representation of a second embodiment of system comprising an assembly with a centrifuge and one or more sensors and a data processing unit with a user interface unit connected therewith, configured to execute a method according to claim 1;

FIG. 3 a schematic representation of a section of a third embodiment;

FIG. 4, 5 various exemplary user interfaces;

FIG. 6 a block diagram of the AKPI determination based on two or more specific KPIs;

FIG. 7 a block diagram of exemplary KPIs and operating parameters; and

FIG. 8 another block diagram of exemplary KPIs and operating parameters; and

FIG. 9 a block diagram that illustrates scrolling between different pages of exemplary user interfaces.

### DETAILED DESCRIPTION

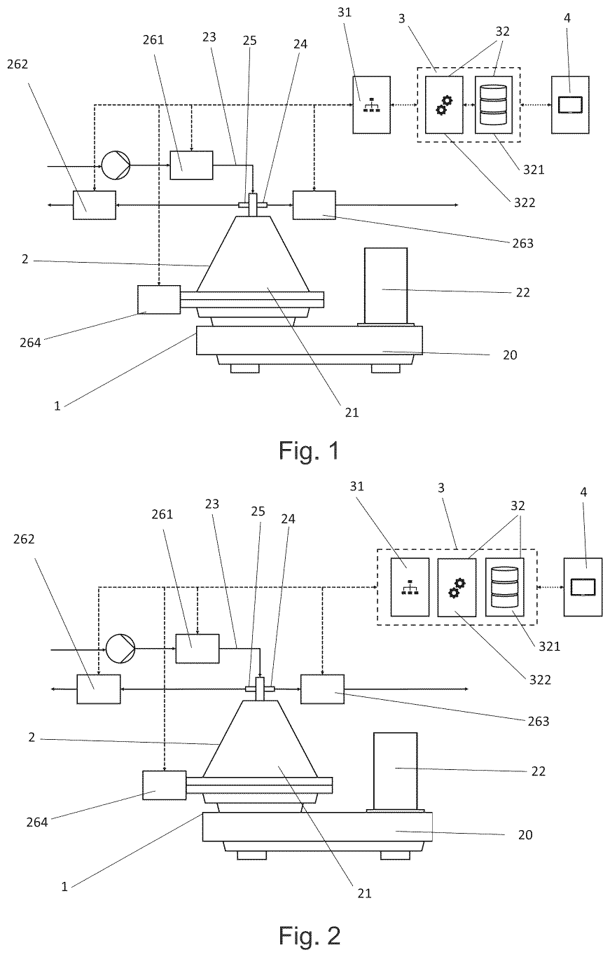

FIG. 1 illustrates an example system 1, comprising an assembly comprising a centrifuge 2, multiple sensors 261, 262, 263, 264 and a data processing unit 3, configured for executing a method for detecting and displaying one or more key performance indicator representing a centrifugal separation process carried out with an assembly comprising a centrifuge, with a user interface unit 4 connected therewith.

The centrifuge 2 of the assembly is provided for executing a separation process which separates a fluid—a suspension—in components of different density in a centrifugal field.

An example of a centrifuge 2 is shown in FIG. 1. This centrifuge 2 may be a continuous feed centrifugal separator. This centrifugal separator comprises a machine frame 20 with a housing 21 in which a rotor (not shown) is arranged. The rotor comprises a rotatable bowl. Preferably, the centrifuge is a disc stack separator or a decanter. In a disc stack separator, the bowl comprises a disc stack for effective separation.

The rotor of the centrifuge is arranged to rotate about an axis of rotation by means of a drive 22. The bowl comprises a separation chamber in which a centrifugal separation of two or more components of a fluid (i.e., a suspension) takes place during operation.

An inlet pipe 23 for feeding the fluid for centrifugal separation extends in the bowl. A first outlet pipe 24 for discharging a first one of the components of the fluid extends from the bowl. Further, a second outlet pipe 25 for discharging a second one of the components of the fluid extends from the bowl. The bowl can be provided with additional outlets, for example for continuously or discontinuously discharging a sludge of solids from the bowl or for separator cleaning.

In accordance with the invention, the assembly comprising the centrifuge 2 comprises means of detection comprising several sensors 261 to 264. These sensors 261 to 264 may comprise one or both of internal sensors provided in the bowl and external sensors provided outside of the bowl. Furthermore, the sensors can be provided on or inside all parts of the assembly.

Electronic parts of the system 1 may comprise wired connections and/or may communicate wirelessly.

In FIG. 1, by way of example, the centrifuge comprises four sensors 261, 262, 263, 264: All of these exemplary sensors 261 to 264 are provided outside of the bowl.

A first of the sensors 261 is provided in the inlet pipe 23. This first sensor 261 can be designed as a flowmeter, particularly as a volumetric or a mass flow meter. Also, in FIG. 1, the first outlet pipe 24 comprises the second sensor 263 and the second outlet pipe 25 comprises the third sensor 262. These second and third sensors 262, 263 can also be designed as flowmeters. In addition to this, a fourth sensor 264 can be provided at the centrifuge. This sensor can be a vibration sensor designed to measure vibrations, for example of the machine frame 20.

These sensors 261, 262, 263, 264 are provided for detecting operating parameters (OPs) of the process. They are connected to a data processing unit 3.

The data processing unit 3 may comprise a data acquisition unit 31.

The data processing unit 3 may comprise at least one or more electronic circuit(s), which comprises one or more of: discrete components, printed circuit boards, or integrated circuits. The one or more integrated circuits may comprise one or more of an application specific integrated circuit, a microcontroller, a microprocessor, or a field-programmable gate array.

This data acquisition 31 unit can form a part of or can be connected to a control unit, such as a process controller for controlling the centrifugal separation process. The data acquisition unit 31 acquires measurement data from sensors 261, 262, 263, 264.

In addition to this, the data acquisition unit 31 can comprise a gateway. The gateway can be designed to provide data transfer to a computing unit 32. This computing unit may comprise a data storage unit 321 and a data processor 322. The computing unit 32 can be connected to the user interface unit 4 which is preferably designed as a display unit 4.

The centrifugal process controller may use the data collected by the one or more sensors 261, 262, 263, 264—i.e., the detected operating parameters—for controlling the centrifugal separation process.

In the embodiment shown in FIG. 1, the computing unit 32 can also process the data collected by the sensors 261 to 264. The computing unit 32 uses the data for determining key performance indicators.

The computing unit 32 can be designed in different ways. In one embodiment, it may be designed as a computing unit at or close to the site where the arrangement comprising the centrifuge is located. However, it can also be located at a different, remote location with wired or wireless connections. Also, it can be designed as a remote computing unit, for example as a cloud computing unit. In FIG. 2, the data acquisition unit 31 and the computing unit 32 are parts of one computer that embodies the data processing unit 3, and which can be a local or a cloud computer. In this case, the controller for controlling the centrifugal separation process may also be used as or comprise the data processor 322 determining the key performance indicators.

The computing unit 32 converts the detected operating parameters into two or more respective specific key performance indicators KPI1 and KPI2, and determines an aggregate key performance indicator AKPI from the two or more specific key performance indicators KPI and/or the sub KPIs by applying a predetermined set of rules to the two or more specific key performance indicators. The AKPI changes when changes happen to the equipment.

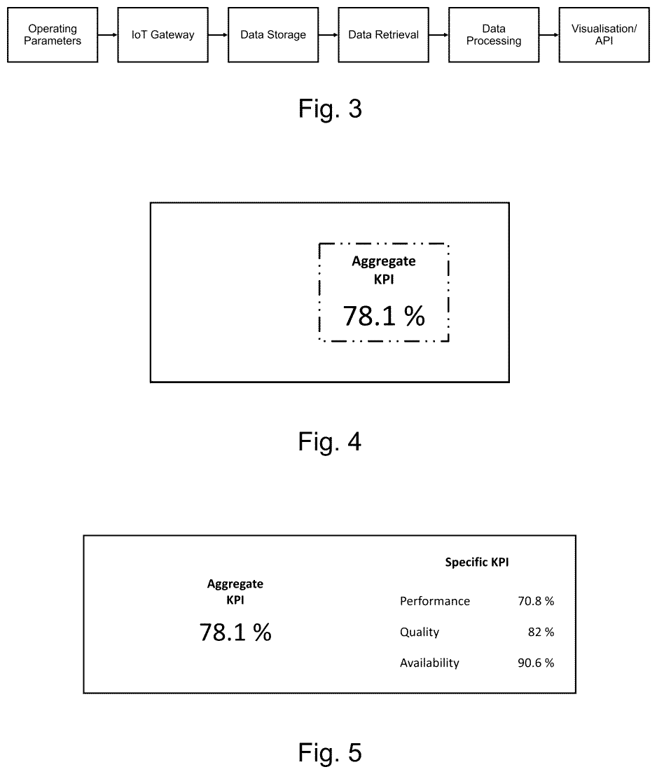

FIG. 3 shows a schematic representation of a section of a third exemplary embodiment of the present invention. The detected operating parameters (data) are transferred to the data storage unit 322 (not shown) via an Internet-of-Things (IoT) gateway for data storage. Upon data retrieval, the stored data are processed for subsequent visualization on the user interface unit 4 (not shown). Alternatively, or additionally, an application programming interface can be provided for data transmission.

An exemplary embodiment of the visualization of the data by displaying the aggregate key performance indicator on the user interface 4 is shown in FIG. 4. It is also possible to display additional information, for example, the two or more respective specific key performance indicators KPI1 and KPI2, as shown in FIG. 5. The user interface in FIG. 4 or FIG. 5 is configured as a touch display, such that a user can access and view the different stages of the calculation of the AKPI, for example the operating parameters or KPI1 and KPI2. The user is thus enabled to determine the cause of changes to the AKPI.

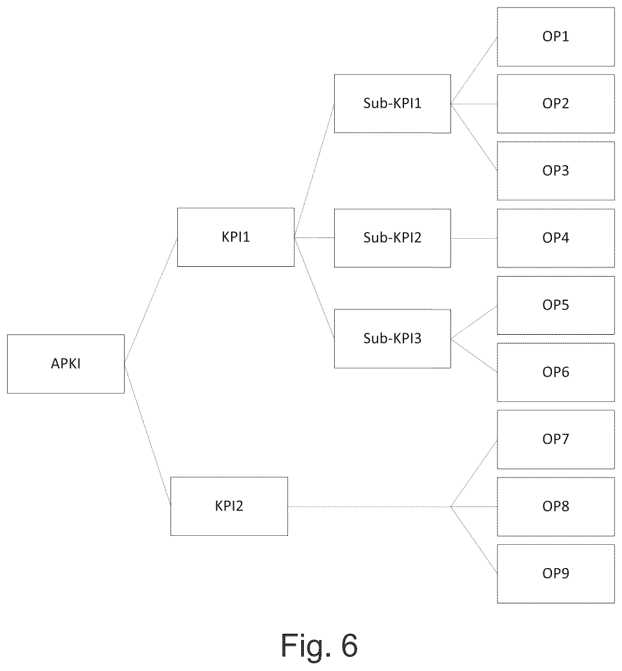

A block diagram to illustrate the data content of the AKPI is shown in FIG. 6. The AKPI is calculated by determining a weighted average of two or more specific KPIs: KPI1 and KPI2. KPI1 is determined from one or more Sub KPIs: Sub KPI1, Sub KPI2 and Sub KPI3. These are, in turn, determined from one or more system operating parameters: OP1, OP2, and OP3 are used to determine Sub KPI1, OP4 is used to determine Sub KPI2, and OP5 and OP6 are used to determine Sub KPI3, respectively. KPI2 is calculated as a weighted average of operating parameters OP7, OP8, and OP9. The topology of the block diagram in FIG. 6 can be extended and/or adapted infinitely to suit the precise needs of the system operator. An operator can thus access multiple levels of pooled machine data and hence identify areas of concern more easily.

As shown in FIG. 6, it is possible that a KPI like KPI1 and KPI2 or a Sub KPI like Sub-KPI1 is directly calculated from one or more of the one, two or more different operating parameters, respectively. However, it is also possible that one or more of the respective Sub key performance indicators are calculated from one or more Sub Sub key performance indicators, of which one or more—in turn—is calculated from the one, two or more (different) operating parameters, respectively. Thus, it is either possible that one or more of the respective KPI or one or more of the Sub KPIs or one or more of the Sub Sub key performance indicators is calculated from the two or more different operating parameters, respectively.

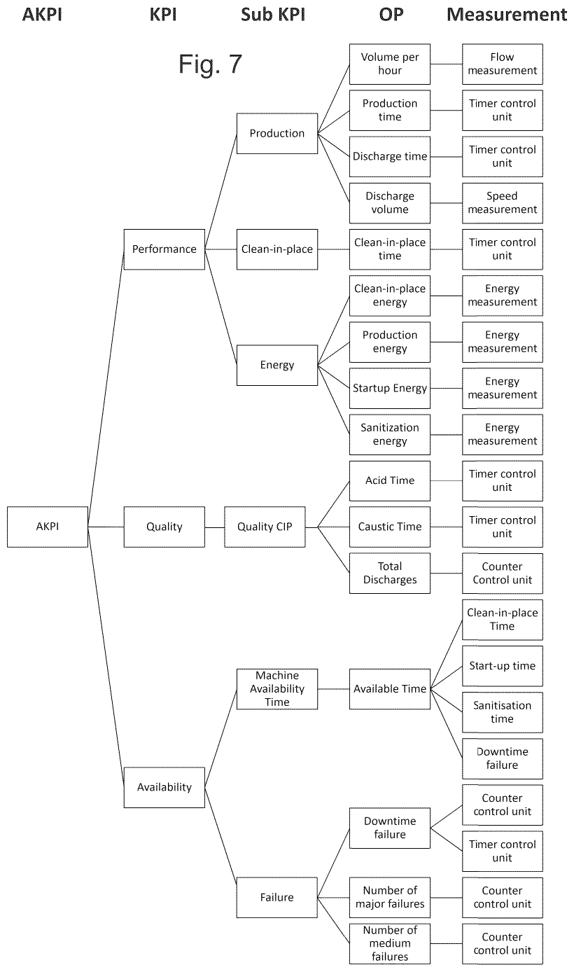

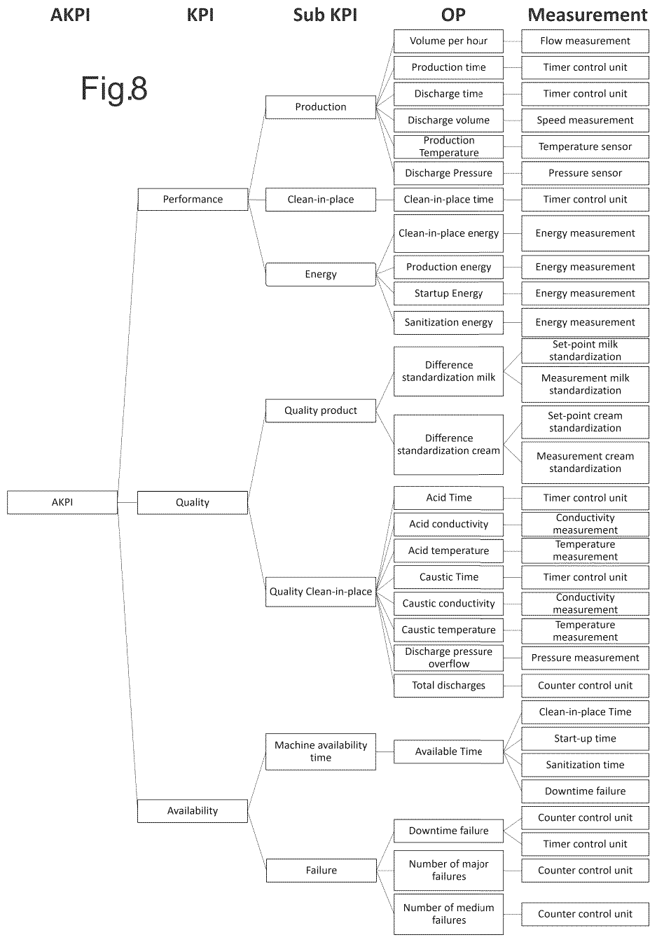

In the two more specific exemplary embodiments of FIGS. 7 and 8, the AKPI is calculated as a weighted average of the following specific KPIs:
performance, which can be calculated as a weighted average of the following specific KPIs: production, clean-in-place and energy;
quality, which can be calculated from a Sub KPI Quality CIP (quality clean-in-place); and
availability, which can be calculated as a weighted average of the following Sub KPIs: available time and failure.

In FIG. 7, to establish the Sub KPI production, the Sub KPI production is determined by calculation as a weighted average of the operating parameters: volume per hour, production time, discharge time and discharge volume.

In FIG. 7, to establish the KPI clean in place (CIP), the Sub KPI production is calculated from the operating parameter CIP time.

Also, in FIG. 7 the Sub KPI energy is calculated as a weighted average from the following operating parameters: clean-in-place-energy, production energy, start-up energy, and sanitization energy.

The Sub KPI quality cleaning in place can be calculated as a weighted average from the operating parameters acid time; caustic time and total discharges.

The available time can be an operating parameter that is directly measured or it can be a Sub KPI and/or Sub Sub KPI. To establish the OP/Sub Sub KPI available time, this can also be calculated as a weighted average from the operating parameters clean-in-place time, start-up-time, sanitization time and downtime failure.

The Sub KPI failure can be calculated as a weighted average of the following failure operating parameters: Failure downtime and number of major failures and number of medium failures.

The following describes how several of the operating parameters can be determined easily in a preferred embodiment (especially in the embodiment of FIGS. 7 and 8). However, this can also be done in other ways in other embodiments. The operating parameter volume per hour can be determined by flow measurement. The operating parameter production time per hour can be determined by a timer control unit. The operating parameter discharge time per hour can be determined by a timer control unit. The operating parameter discharge volume per hour can be determined by different kind of measurements, e.g., a speed measurement. The operating parameter CIP time can be determined by a timer control unit. The operating parameter CIP energy can be determined by an energy measurement. The operating parameter production energy can be determined by an energy measurement. The operating parameter startup energy can be determined by an energy measurement. The operating parameter sanitization energy can be determined by an energy measurement. The operating parameter acid time can be determined by a timer control unit. The operating parameter caustic time can be determined by a timer control unit. The operating parameter total discharges can be determined by a counter control unit. The operating parameter downtime failure can be determined by counter control unit and a timer control unit. The operating parameter number of major failures can be determined by a counter control unit. The operating parameter number of medium failures can be determined by a counter control unit.

In this embodiment, a system operator can thus investigate not only whether the system is operating as expected overall or in performance, quality or availability, but also, for example whether its performance is affected by the system's production, clean-in-place process, or energy consumption, as well as the direct cause of any changes to these Sub KPIs or Sub Sub KPIs in terms of the determined operating parameters.

Additionally, through the application of weights, the present invention can better account for the relative importance of different key performance indicators and operating parameters than the state of the art. These factors result in a more efficient use of limited maintenance and development resources.

The AKPI may also be an average of weighted or unweighted KPIs. The AKPI will be defined but is not limited to the KPIs performance, quality & availability.

Since weighting will be used, a comparable weighting system like for the Sub Sub and Sub KPIs will be implemented
Weighting w (1-5, or adapted to the needs).
Median of the KPI with the weighting is then giving the AKPI

$$AKPI = \frac{\begin{matrix}KPI 1 * {w}_{KPI 1} + KPI 2 * {w}_{KPI 2} + \\ KPI 3 * {w}_{KPI 3} + … + KPI n * {w}_{KPI n}\end{matrix}}{{w}_{KPI 1} + {w}_{KPI 2} + {w}_{KPI 3} + … + {w}_{KPI n}}$$

The AKPI Dashboard could also include measurements from the separator, and process related data, particularly for dairy and beverage applications.

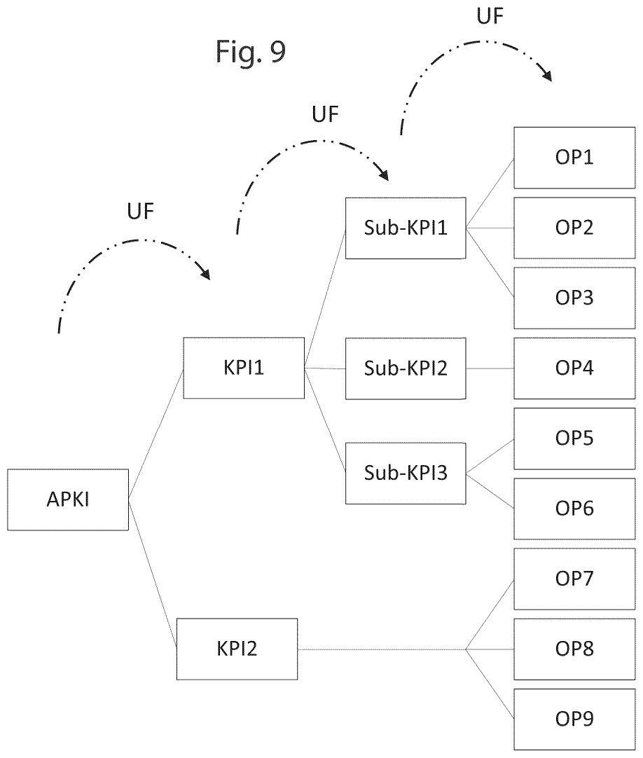

By showing different KPIs on one or more dashboards on a screen (AKPI and Sub KPI and operating parameters (FIG. 9)), the user gains a better/faster overview of the efficiency of the separator. Also, the user may react faster when issues arise.

In different preferred embodiments, the centrifugal separation process executed with the assembly comprising the centrifuge can include further steps by which the phases can be processed further.

The block diagram of exemplary KPIs and operating parameters shown in FIG. 7 and the alternatives described above can be used with different kinds of centrifugal processes. However, the invention can be implemented in a particularly advantageous manner in the processes listed in the introductory part of the description.

In these individual processes listed above, it can be useful to consider further parameters.

A particularly advantageous example process, i.e., a particularly advantageous example centrifugal separation process that can be used to carry out the claimed method, concerns the centrifugal processing of milk and/or other dairy products into different product phases. As an example, milk may be separated into the two phases, cream with high fat content and skimmed milk with a lower fat content, by using a centrifugal separator.

Many dairy processes require an additional standardization of the composition of the milk phases. Standardizing milk might require control of only one component (usually fat), while allowing the others to vary or control two or more components simultaneously.

Typically, in a system as shown in FIG. 1, the centrifuge is a disc separator for continuous processing. Further, typically, at least one of the phases discharged from the separator can be added to the other phase in a controlled manner.

Standardization may require the integration of a computerized control device (also called “standardizing unit”) to the skimming separator.

The skimming separator might be a milk skimming separator but it can also be a whey separator. The standardizing unit controls the flow of cream out of the milk skimming separator and may measure the flow or mass and density of the cream with one or more of the sensor(s). Thus, since the density is known, the fat content of the cream can be calculated by using formulas known in the art. The unit then adds cream in relation to the flow of skim milk and the fat content which is desired in the final milk. The surplus cream is then discharged to an additional “surplus cream” tank.

This way, a variation of different fat contents can be adjusted in the milk for the needed applications like cheese milk, drink milk.

FIG. 8 shows another block diagram of exemplary KPIs and operating parameters which can be used if the centrifugation process comprises a standardization of one or more of the phases discharged from the centrifugal separator.

In FIG. 8, in comparison with FIG. 7, several fields were added.

In FIG. 8, to establish the Sub KPI production, the Sub KPI production is calculated as a weighted average of the operating parameters: volume per hour, production time, discharge time, discharge volume, production temperature, and discharge pressure.

In FIG. 8, to establish the KPI clean in place (CIP), the Sub KPI production is calculated from operating parameter: clean in place time, which can be determined by a timer control unit.

Also, in FIG. 8 the Sub KPI energy is calculated as a weighted average of the following operating parameters: clean-in-place energy, production energy, start-up energy, and sanitization energy.

To establish an additional Sub KPI quality product, this can be calculated as a weighted average from the operating parameters (which can in this case also be called Sub Sub KPIs) difference standardization milk and difference standardization cream.

To establish the Sub KPI quality cleaning in place, this can be calculated as a weighted average from the operating parameters acid time; acid conductivity, acid temperature, caustic time, caustic conductivity, caustic temperature, discharge pressure overflow, and total discharges.

To establish the Sub KPI machine availability time, this can be calculated as a weighted average from the OP (which in this case can also be called Sub Sub KPI) available time, which can in turn be determined from the operating parameters CIP time, start-up-time, sanitization time, and downtime failure.

To establish the Sub KPI failure, this can be calculated as a weighted average from the operating parameters downtime failure, number of major failures, and number of medium failures.

The following describes how several of the operating parameters can easily be determined in the embodiment of FIG. 8. The operating parameter production temperature can be determined by a temperature sensor. The operating parameter discharge pressure can be determined by a pressure sensor. The operating parameter acid conductivity can be determined by a conductivity measurement.

The operating parameter acid temperature can be measured by a temperature sensor. The operating parameter discharge pressure overflow can be determined by a pressure measurement.

The Sub Sub KPI difference standardization milk can be calculated from an operating parameter calculated from a set point milk standardization and a measurement of the milk standardization.

The Sub Sub KPI difference standardization cream can be calculated from a set point cream standardization and a measurement of the cream standardization.

In addition to the explanations given before, several of the terms used in FIG. 7 and of FIG. 8 are explained in the list below (OP=Operating parameter).

| AKPI/KPI/Sub KPI/OP | Description/Measurement |
|---|---|
| 1. AKPI | The aggregate key performance |
| | indicator is determined from two or more |
| | specific key performance indicators |
| | through applying a predetermined set of |
| | rules to determine a weighted average of |
| | the two or more specific key |
| | performance indicators. It can be |
| | regarded as a custom value to evaluate |
| | the overall process optimization. |
| 1.1 KPI Performance | The value indicates the machine |
| | performance, calculated from production |
| | performance, CIP-Performance and |
| | Energy performance. |
| 1.1.1 Sub KPI Production | The value indicates the production- |
| | performance, which is calculated from |
| | production volume per hour, production |
| | time, discharge time and discharge |
| | volume during production. In case a |
| | “control unit” is installed discharge |
| | pressure and product temperature will |
| | also be included. |
| 1.1.1.1 OP Volume per hour | The reduction volume per hour in |
| | production cycle of the machine. |
| 1.1.1.2 OP Production Time | The total running time of the machine |
| | during production cycle. |
| 1.1.1.3 OP Discharge Time | The discharge duration during the |
| | production time. |
| 1.1.1.4 OP Discharge Volume | The discharge volume during ejection. |
| 1.1.1.5 OP Discharge Pressure | The pressure of the product at the |
| | output. |
| 1.1.1.6 OP Production Temperature | The temperature during production |
| | cycle. |
| 1.1.2 KPI CIP | The value indicates the performance of |
| | the cleaning process, which is calculated |
| | from the durations of the cleaning cycle, |
| | acid step, caustic step, and the total |
| | discharges during the whole cleaning |
| | process. |
| 1.1.2.1 OP CIP time | The total duration of the cleaning |
| | process. |
| 1.1.3 KPI Energy | The value indicates the energy |
| | performance, which is calculated from |
| | the energy consumption during the |
| | cleaning process, production, startup, |
| | and sanitization. |
| 1.1.3.1 OP CIP Energy | The energy consumption during the |
| | cleaning process. |
| 1.1.3.2 OP Production Energy | The energy consumption during the |
| | production. |
| 1.1.3.3 OP Startup Energy | The energy consumption during startup. |
| 1.1.3.4 OP Sanitization Energy | The energy consumption during the |
| | sanitization phase. |
| 1.2 KPI Quality | The value indicates the machine quality, |
| | calculated from quality CIP and quality |
| | product. |
| 1.2.1 Sub KPI Quality CIP | The value indicates the CIP-Quality, |
| | which is calculated from the acid and |
| | caustic times and the number of |
| | discharges. In case a control unit is |
| | installed, the average conductivity and |
| | temperature of acid and caustic as well |
| | as the average pressure of the |
| | discharge overflow also be included. |
| 1.2.1.1 OP Caustic Time | The time in CIP cycle when circulating |
| | caustic. |
| 1.2.1.2 OP Caustic Temperature | The temperature during caustic cleaning. |
| 1.2.1.3 OP Caustic Conductivity | The conductivity during caustic cleaning |
| | can give a hint on the quality of the |
| | cleaning process. |
| 1.2.1.4 OP Acid Time | The time in CIP cycle when circulating |
| | acid. |
| 1.2.1.5 OP Acid Temperature | The temperature during acid cleaning. |
| 1.2.1.6 OP Acid Conductivity | The conductivity during acid cleaning |
| | can give a hint on the quality of the |
| | cleaning process. |
| 1.2.1.7 OP Total Discharges | The number of discharges during CIP. |
| 1.2.1.8 OP Discharge Pressure | The discharge pressure during CIP |
| Overflow | overflow. |
| 1.2.2 Sub KPI Quality Product | The value indicates the product quality, |
| | which is calculated from the control unit |
| | values about cream and milk |
| | standardization. |
| 1.2.2.1Sub Sub KPI Difference | How well the standardization of cream is |
| Standardization Cream | working. |
| 1.2.2.2 Sub Sub KPI Difference | How well the standardization of milk is |
| Standardization Milk | working. |
| 1.3 KPI Availability | The value indicates the machine |
| | availability, calculated from machine |
| | availability time and the failures. |
| 1.3.1 SUB KPI Available Time | The value indicates the machine |
| | availability, which is calculated from the |
| | total available time. |
| 1.3.1.1 Sub Sub KPI Available Time | The theoretical time available for |
| | production after deduction of the CIP-, |
| | startup-, sanitization- and down-time. |
| OP CIP Time | The total duration of the cleaning |
| | process. |
| OP Startup Time | The duration until the machine is started |
| | up and can be used for production. |
| OP Sanitization time | The duration of the sanitization phase. |
| OP Failure downtime | The downtime caused by malfunctions |
| | on the machine. |
| 1.3.2 Sub KPI Failure | The value indicates the Failures, which |
| | are calculated from the total downtime |
| | failure and the number of medium and |
| | major failures on the machine. |
| 1.3.2.1 OP Downtime failure | The total downtime caused by |
| | malfunctions on the machine. |
| 1.3.2.2 OP Number of medium failures | The number of medium failures on the |
| | machine (e.g. pre-alarms). |
| 1.3.2.3 OP Number of major failures | The number of major failures on the |
| | machine (e.g. failures leading to |
| | shutdown of the machine). |

Preferably, the following measurements of operating parameters may be carried out with sensors:

| Type of measurement | Short description |
|---|---|
| Flow meter | Flow meter for measuring the flow and counting the |
| | amount of milk produced |
| Pressure Gauge | Pressure gauge for measurement of the discharge |
| | pressure heavy phase |
| Signal exchange | Signal exchange via a bus system like |
| | ProfiBus/Ethernet or equal to send status of the plan |
| | (CIP, Production, SIP—Sterilizing In PlaceStart) |
| Speed control separator | Speed control of the separator |
| Current and power (and | Current and power measurement for the power |
| operating time) measurement | needed for running the separator |
| Vibration measurement | Vibration measurement for machine control |
| Condition Monitoring | Condition monitoring of the separator |
| Discharge flow | Flow meter in the discharge |
| Turbidity measurement | Turbidity measurement for whey separation |
| | (optional) |

As explained above in preferred embodiments, for example in the embodiments according to the Figures described above, the KPIs—for example performance, quality and availability—can be split into Sub KPIs. In turn, sub KPIs may be split into Sub Sub KPIs. The lowest level of the KPIs can be calculated from the determined operating parameters.

Single Sub Sub KPIs or Sub KPIs can be analyzed for a specific target time, variable by the user.

The KPIs may be evaluated by using a model of deviation with a previous filed target value.

The deviation is then used to scale the KPI from 0 to 100% in target bands. The bands are predefined when the system is started up, but can also be adjusted afterwards, for example to accommodate a change in user requirements.

Every KPI, Sub KPIS and/or Sub Sub KPI can be set to individual ranges and percentages.

| Deviation (%) | KPI Value (%) |
|---|---|
| 0-5 | 100 |
| 5-10 | 90 |
| 10-15 | 80 |
| 15-20 | 70 |
| 20-25 | 60 |
| 25-30 | 50 |
| 30-35 | 40 |
| 35-40 | 30 |
| 40-45 | 20 |
| 45-50 | 10 |
| 50-100 | 1 |

The one or more Sub KPI(s) or Sub Sub KPI(s) may then be given a weighting factor, for example 1 to 5 or equivalent.

The method of calculation may be chosen an accordance with the type of KPI or Sub KPI or Sub Sub KPI and with the type of the operating parameter. This means the KPI Performance may consist of different Sub KPIs and Sub Sub KPIs, which may be weighted according to the process and also for the efficiency of the assembly.

This is be explained hereafter with regard to different examples.

For the evaluation of the effectiveness of a process, a capacity view and a process view for product quality are typically of higher importance than the typical time between desludges (sludge discharge). However, with a standard model without any weighting, changes in the desludging time would influence the KPI equally to all other parameters.

In order to explain the influence of a weighted KPI method more clearly, the present invention is compared to a method according to the state of the art which uses an unweighted KPI, meaning all Sub and Sub Sub KPIs have equal weight.

The Sub KPI can be a single evaluated KPI with a comparison of a determined value to a target value, a calculated value to a target value or an average of different Sub Sub KPIs, with or without a weighted inclusion of the single KPIs
Weighted KPI Measurement:

$$KPI = \frac{\begin{matrix}Sub KPI 1 \times {w}_{Sub KPI 1} + Sub KPI 2 \times {w}_{KPI 2} + \\ Sub KPI 3 \times {w}_{KPI3} + … + Sub KPI n \times {w}_{KPI n}\end{matrix}}{{w}_{Sub KPI 1} + {w}_{KPI 2} + {w}_{KPI 3} + … + {w}_{KPI n}}$$

As an example, the Sub Sub KPI Production time that is important for the Sub KPI production might assign higher weight (value of w) to the volume produced per hour and the running time than for the desludge time or the amount desludged.
Unweighted KPI Measurement Average

$$KPI = \frac{Sub KPI 1 + Sub KPI 2 + Sub KPI 3 + … + Sub KPI n}{{n}_{Sub KPI}}$$

KPI with multiplication:

$$KPI = Sub KPI 1 \times Sub KPI 2 \times … \times Sub KPI n$$

The unweighted methods cannot reflect variations to some KPIs/Sub KPIs etc. more than variations to other KPIs/Sub KPIs etc.

### Setting of Weights:

Preferably, a weight can be set on the basis of past performance data, of experience and/or can be adjusted in accordance with user focus areas for KPI/Sub KPI or Sub Sub KPI. In this manner, the AKPI model can easily be adjusted to the customer's definition of assembly efficiency.

Thus, the user gets a pre-defined definition of the AKPI with the possibility to adjust it to his needs and requirements.

Also, less important KPI/Sub KPI/Sub Sub KPI can be reduced in weight to ensure that these do not affect the AKPI heavily when worsening.

As an example, important factors of a centrifugal separation process may be the capacity and the temperature. Less important factors of this process may be the sanitization time or the time between discharging the bowl of a self-emptying centrifuge.

A user, like a production manager, gains a more meaningful awareness of the separator performance and can detect a failure and/or potential hazards by unfolding a KPI structure (arrows UF) on a dashboard of a screen as shown in FIG. 9.

Weighting provides the possibility to ensure that more critical parameter like flow rate have a higher impact on the OEE. This way, a reduction of the KPI has a higher influence on the OEE.—Critical process issues are seen faster than less important ones.

The following is an example of a calculation of a KPI. The KPI to be calculated is a target feed flow (unit: volume per hour):

The target feed flow value to be achieved may have been previously defined, e.g. by a contract of the separator, by manual adaption of a customer or by definition, e.g. by AI or by trial and error.
For a separator for skimming (for example of milk), a flow of 40 m³/h shall be achieved;
The average feed flow can be calculated by using feed flow data;
The average feed flow can be compared with the target feed flow;
If the difference is below 5% the KPI target feed flow value will be 100%;
If the value is between 5 and 10%, it will be 90;

Example 1: Target value 40 m³/h, average value=37.5 m³/h:

$$Sub Sub KPI target feed flow = ( ( \frac{37.5}{40} ) - 1 ) \times 100 = 6.25 \% deviation \to Efficiency 90 \%$$

Example 2: Target value 40 m³/h, average value=35.0 m³/h:

$$Sub Sub KPI target feed flow = ( ( \frac{35}{40} ) - 1 ) \times 100 = 12.5 \% deviation \to Efficiency 80 \%$$

For fine tuning of the respective KPI and the efficiency, the range for the efficiency can be adapted/changed with ongoing experience. The shown values are just examples to explain the method.

The Sub KPI can be calculated from different and/or differently weighted values:

### Example 1

A Sub KPI Performance may consist of the Sub Sub KPIs:

$$Volume per hour ( KPI 1 ) ( Example value = 100 \% ) - weight 1 ( W 1 ) = 5$$

$$Production time ( KPI 2 ) ( Example value = 80 \% ) - weight 2 ( W 2 ) = 4$$

$$Discharge time ( KPI 3 ) ( Example value = 90 \% ) - weight 3 ( W 3 ) = 2$$

$$Discharge amount ( KPI 4 ) ( Example value = 70 \% ) - weight 4 ( W 4 ) = 3$$

Every weight is then given a weighting (i.e. weights 1 to 5 with values between 2 and 5), the denominator of the following equation is the sum of all weights.

$$Sub KPI Performance = \frac{\begin{matrix}KPI 1 \times W 1 + KPI 2 \times W 2 + \\ KPI 3 \times W 3 + KPI 4 \times W 4\end{matrix}}{W 1 + W 2 + W 3 + W 4} = \frac{100 \times 5 + 80 \times 4 + 90 \times 2 + 70 \times 3}{14} = 86.42 ( \% )$$

### Example 2

Weightings are the same as in Example 1, but the KPI values have changed because of the operating parameters.

A Sub KPI Performance may consist of the Sub Sub KPIs:

$$Volume per hour ( KPI 1 ) ( Example value = 70 \% )$$

$$Production time ( KPi2 ) ( Example value = 60 \% )$$

$$Discharge time ( KPI 3 ) ( Example value = 100 \% )$$

$$Discharge amount ( KPI 4 ) ( Example value = 100 \% )$$

$$Sub KPI Performance = \frac{70 \times 5 + 60 \times 4 + 100 \times 2 + 100 \times 3}{14} = 77.86 ( \% )$$

KPIs can also be calculated by using a weighted Sub KPI average or by Sub KPI averaging without weighting.

### Example 1b: KPI Performance

A Sub KPI Performance may consist of the Sub Sub KPIs:

$$Sub KPI Production ( KPI 1 ) , ( Example value = 77 \% ) - weight 1 ( W 1 ) = 5$$

$$Sub KPI CIP ( KPI 2 ) ( Example value = 64 \% ) - weight 2 ( W 2 ) = 3$$

$$Sub KPI Energy ( KPI 3 ) ( Example value = 85 \% ) - weight 3 ( W 3 ) = 5$$

$$Sub KPI Performance = \frac{KPI 1 \times W 1 + KPI 2 \times W 2 + KPI 3 \times W 3}{W 1 + W 2 + W 3} = \frac{77 \times 5 + 64 \times 3 + 85 \times 5}{13} = 77.08 ( \% )$$

The AKPI is then calculated by using a weighted average of the three KPI's performance, quality and availability.

### Example 2b

A KPI Performance may consist of the Sub Sub KPIs:

$$KPI Production ( KPI 1 ) ( Example value = 77 \% ) - weight 1 ( W 1 ) = 5$$

$$KPI Quality ( KPI 2 ) ( Example value = 92 \% ) - weight 2 ( W 2 ) = 3$$

$$KPI Availability ( KPI 3 ) ( Example value = 54 \% ) - weight 3 ( W3 ) = 3$$

$$Sub KPI Performance = \frac{77 \times 5 + 92 \times 3 + 54 \times 3}{9} = 74.82 ( \% )$$

In the state of the art, the KPI is determined as follows:

$$KPI = KPI 1 \times KPI 2 \times KPI 3 = ( 0.77 \times 0.92 \times 0.54 ) \times 100 = 38.26 \%$$

Using the state of the art, a change in KPI has a significantly higher impact on the final KPI value.

The present invention also enables the comparison of assemblies with different capacity set-ups, for example a comparison of a separator working for 30 m³/h with a separator working for 50 m³/h in terms of their respective efficiency. Also, it enables a more meaningful comparison of separators located at different sites or on different processing lines. In addition to this, indicating equipment deterioration over time might be achieved through a comparison of aggregate key performance indicator values with a value indicating the equipment performance over a longer term.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMBERS

1 System
2 Centrifuge
3 Data processing unit
4 User interface unit
20 Machine Frame
21 Housing
22 Drive
23 Inlet pipe
24 Outlet pipe
25 Outlet pipe
261 Sensor
262 Sensor
263 Sensor
264 Sensor
31 Data acquisition unit
32 Computing Unit
321 Data storage unit
322 Data processor

1-19. (canceled)

20. A method for detecting and displaying one or more key performance indicators representing a centrifugal separation process performed with an assembly comprising a centrifuge, the method comprising:
A) executing the separation process with the assembly comprising the centrifuge;
B) detecting one, two, or more different operating parameters of the centrifugal separation process of the assembly with the centrifuge using one or more detection means associated with the assembly;
C) converting, by a data processing unit, the detected operating parameters into two or more respective specific key performance indicators;
D) determining an aggregate key performance indicator from the two or more specific key performance indicators by applying a predetermined set of rules to determine a weighted average of the two or more specific key performance indicators; and
E) displaying at least the aggregate key performance indicator on a user interface.

21. The method of claim 20, wherein the respective specific key performance indicators are calculated from two or more Sub key performance indicators, wherein one or more of the two or more Sub key performance indicators is calculated from the two or more different operating parameters, respectively.

22. The method of claim 21, wherein the one or more of the respective Sub key performance indicators are calculated from one or more Sub Sub key performance indicators, wherein one or more of the one or more Sub Sub key performance indicators is calculated from one or more of the two or more different operating parameters, respectively.

23. The method of claim 20, further comprising:
determining weights for the conversion of the detected operating parameters into the two or more key performance indicators prior to step B).

24. The method of claim 20, wherein different panels are opened one after another on a dashboard to unfold the one or more of the key performance indicators into at least two or more Sub key performance indicators.

25. The method of claim 20, wherein the one or more means of detection are associated with the centrifuge and comprise one or more sensors.

26. The method of claim 20, wherein the centrifugation separation process is a separation process separating a fluid as a suspension into components of different density in a centrifugal field.

27. The method of claim 20, wherein the centrifugal separation process executed with the assembly is one of:
milk skimming, milk clarification, bacterial removing of milk/whey, yeast separation in beer or fermented medias, juice separation, whey separation, whey skimming, separation of coffee or concentrated coffee, separation of proteins, separation of animal-based fats, separation of fermentation broth, separation of chemicals, separation of pharmaceutical, separation of yoghurt, separation of butter oil, separation of crude oil, separation of wastewater, and separation of bilge water.

28. The method of claim 20, wherein the one, two, or more operating parameters comprises one or more of:
volume per hour, production time, discharge time, discharge volume, production temperature, discharge pressure, clean-in-place time, clean in place energy, production energy, startup energy, sanitization energy, difference standardization milk, difference standardization cream, acid time, acid conductivity, acid temperature, caustic time, caustic conductivity, caustic temperature, discharge pressure overflow, total discharges, clean in place time, startup time, sanitization time, downtime failure, number of major failures, and number of medium failures.

29. The method of claim 21, wherein the two or more specific key performance indicators comprise at least one or more of the key performance indicators of performance, quality, and availability.

30. The method of claim 29, wherein
the performance key performance indicator is calculated at least from one or more of the Sub key performance indicators of production, clean-in-place, and energy;
the quality key performance indicator is calculated at least from the Sub key performance indicator quality clean-in-place; and
the availability key performance indicator is calculated at least from one or more of the Sub key performance indicators of machine availability time and failure.

31. The method of claim 29, wherein the quality key performance indicator is calculated at least from one or more of the Sub key performance indicators of quality product and quality clean-in-place.

32. The method of claim 30, wherein
the production Sub key performance indicator is calculated from one or more of the operating parameters of volume per unit time, production time, discharge time, discharge volume, production temperature, and discharge pressure; or
the clean-in-place Sub key performance indicator is calculated from one or more of the operating parameters of clean-in-place time, acid time, acid conductivity, acid temperature, caustic time, caustic conductivity, caustic temperature, and total discharges.

33. The method of claim 30, wherein
the energy Sub key performance indicator is calculated from one or more of the operating parameters of clean-in-place energy, production energy, startup energy, and sanitization energy; or
the product quality Sub key performance indicator is calculated from one or more of the operating parameters of difference to standardized milk and difference to standardized cream.

34. The method of claim 30, wherein
the machine availability time Sub key performance indicator is calculated from one or more of the operating parameters of available time, clean-in-place time, start-up time, sanitization time, and failure downtime; or
the failure Sub key performance indicator is calculated from one or more of the operating parameters of failure downtime, number of major failures, and number of medium failures.

35. A system comprising:
an assembly with a centrifuge and one or more sensors; and
a data processing unit with a user interface unit connected to the data processing system, wherein the user interface unit comprises an electronic display comprising a graphical user interface,
wherein the assembly is configured to execute a centrifugal separation process with the assembly,
wherein the one or more sensors are configured to detect one, two, or more different operating parameters of the centrifugal separation process of the assembly,
wherein the data processing unit is configured to convert the detected operating parameters into two or more respective specific key performance indicators,
wherein the data processing unit is configured to determine an aggregate key performance indicator from the two or more specific key performance indicators by applying a predetermined set of rules to determine a weighted average of the two or more specific key performance indicators, and
wherein the graphical user interface is configured to display at least the aggregate key performance indicator.

36. The system of claim 35, wherein the data processing unit comprises a programmable logic controller, a data acquisition unit, a storage unit, and a data processor.

37. The system of claim 35, wherein the data processing unit comprises a cloud computing unit which comprises a storage unit.

38. A non-transitory computer-readable medium comprising program instructions for detecting and displaying one or more key performance indicators representing a centrifugal separation process performed with an assembly comprising a centrifuge, wherein execution of the program instructions causes:
A) executing the separation process with the assembly comprising the centrifuge;
B) detecting one, two, or more different operating parameters of the centrifugal separation process of the assembly with the centrifuge using one or more detection means associated with the assembly;
C) converting, by a data processing unit, the detected operating parameters into two or more respective specific key performance indicators;
D) determining an aggregate key performance indicator from the two or more specific key performance indicators by applying a predetermined set of rules to determine a weighted average of the two or more specific key performance indicators; and
E) displaying at least the aggregate key performance indicator on a user interface.
